(19) United States
(12) Patent Application Publication
(10) Pub. No.: US 2021/0206041 A1
(43) Pub. Date: Jul. 8, 2021

(54) Melt Pressure Control of Injection Molding

(71) Applicant: IMFLUX INC., Hamilton, OH (US)

(72) Inventors: Gene Michael Altonen, West Chester, OH (US); Bryler Collins, Milford, OH (US); Ethan David Stiefel, Mason, OH (US); Herbert Kenneth Hanson, III, Cincinnati, OH (US); William Francis Lawless, III, Medford, MA (US)

(21) Appl. No.: 17/125,277

(22) Filed: Dec. 17, 2020

Related U.S. Application Data
(60) Provisional application No. 62/957,628, filed on Jan. 6, 2020.

(51) Int. Cl. B29C 45/77

(52) U.S. Cl. CPC B29C 45/77; B29C 2945/76187; B29C 2945/76006; B29C 2945/76859; B29C 2945/76498; B29C 2945/76665; B29C 2945/76381

(57) ABSTRACT

A method and system for adjusting melt pressure in an injection molding material that allows calculating a melt pressure of a molten plastic material to be injected and based on the calculated melt pressure and a desired melt pressure adjusting operation of an injection molding machine. This control of an injection molding cycle using the method and system of plastic melt pressure determination allows production of parts of increased quality and consistency.

### CROSS-REFERENCE TO RELATED APPLICATION

This application claims the benefit under 35 U.S.C. § 119(e) of U.S. Provisional Patent Application No. 62/957,628, filed Jan. 6, 2020, the entirety of which is hereby incorporated by reference.

### FIELD OF THE DISCLOSURE

The present disclosure relates generally to injection molding and, more particularly, to approaches for more accurately determining actual plastic melt pressure for injection molding machines using a load cell value or hydraulic pressure value in conjunction with an algorithm that incorporates hydraulic advantage, frictional forces, and melt compression.

### BACKGROUND

Injection molding is a technology commonly used for high-volume manufacturing of parts constructed of thermoplastic materials. During repetitive injection molding processes, a thermoplastic resin, typically in the form of small pellets or beads, is introduced into an injection molding machine which melts the pellets under heat, pressure and shear. In an injection molding cycle, the molten thermoplastic material is forcefully injected into a mold cavity having a particular desired cavity shape. The injected plastic is held under pressure in the mold cavity and is subsequently cooled and removed as a solidified part having a shape closely resembling the cavity shape of the mold. A single mold may have any number of individual cavities which can be connected to a flow channel by a gate that directs the flow of the molten resin into the cavity. A typical injection molding procedure generally includes four basic operations: (1) heating the plastic in the injection molding machine to allow the plastic to flow under pressure; (2) injecting the melted plastic into a mold cavity or cavities defined between two mold halves that have been closed; (3) allowing the plastic to cool and harden in the cavity or cavities while under pressure; and (4) opening the mold halves and ejecting the part from the mold. Upon ejecting the part from the mold, the device that injects the melted plastic into the mold cavity or cavities (e.g., a screw or an auger) enters a recovery phase in which it returns to an original position.

In these systems, a control system controls the injection molding process according to an injection cycle that defines a series of control values for the various components of the injection molding machine. For example, the injection cycle can be driven by a fixed and/or a variable melt pressure profile wherein the controller uses, for example, an estimated melt pressure based on the injection pressure. The injection cycle may also be controlled by a fixed or variable screw velocity profile wherein the control senses the velocity of the injection screw as input for determining the driving speed applied to the material.

In a conventional injection molding process, there are two phases associated with the filling of the mold. The first is usually referred to as the “fill” phase and is controlled by a screw velocity setpoint(s). Most injection molding machines routinely use between 1-3 velocity setpoints, but machines may allow for up to 10 velocity setpoints during the “fill” phase. The velocity setpoints must be manually entered by the machine operator. Once the plastic part has been filled up to a certain percentage, there is a transfer of the machine control from velocity control to pressure control. The pressure control phase of filling out the part is referred to as the “hold” phase. In some cases, the terms “pack” and “hold” are both used to describe the pressure control phase. Most injection molding machines routinely use between 1-3 pressure setpoints during the “hold” phase, but machines may allow for up to 10 pressure setpoints during the “hold” phase. The pressure setpoints are manually entered by the machine operator.

The injection molding process may vary depending on the type of injection molding being performed. For example, constant low pressure multi-cavity injection molding systems have been developed that inject the molten plastic material into the mold cavity at a substantially constant low pressure, typically less than 6,000 psi, for a single time period or phase. Other injection molding processes include metal injection molding (MIM), reaction injection molding (RIM), liquid injection molding (LIM), structural foam molding and liquid crystal polymer (LCP) molding.

Throughout injection of plastic in an injection molding process, the typical proxy that is used by the injection molding machine for melt pressure is an injection pressure. The injection pressure is typically either the hydraulic pressure exerted on the back of an injection piston or the amount of force exerted on a load cell on the back of a screw. A calculation is made to approximate what the actual plastic melt pressure is at the front of the screw during injection by comparing the difference in area between where the force or pressure is being measured and the area of the screw tip that is exerted on the molten thermoplastic material. Typically, this comparison is called the intensification ratio. The calculation that is used depends on whether the machine injection is controlled hydraulically or electrically. This method of calculating actual melt pressure can be compromised by the variation in geometry at the front of the screw tip, as well as variation due to pressure drop based on one or more of the following; clearance between screw and barrel, screw check ring performance, and the geometry of additional components such as mixers or extended nozzles. Other factors which add to the error in calculating melt pressure include frictional or drag forces as well as the compressive nature of the molten plastic during the injection molding process.

### SUMMARY

Arrangements within the scope of the present disclosure are directed to the control of an injection molding process to produce repeatably consistent parts by using a much more accurate melt pressure calculation than the intensification ratio which is the current industry standard. The use of an algorithm that takes intensification ratio combined with dynamic real time frictional force and dynamic real time plastic melt compression in combination with a pressure transducer at or near the back of the screw gives a much more accurate measurement of what the actual plastic melt pressure is of the plastic material that is entering the mold during the fill, pack or hold phases of the injection molding cycle than the injection pressure currently being used as a proxy. In other words, control of an injection molding cycle using current injection pressure techniques (such as a hydraulic or electric pressure) will yield varying actual plastic melt pressure for most of the fill, pack and hold phase, which will result in parts of reduced quality and consistency, whereas control of an injection molding cycle using the proposed improved method of plastic melt pressure determination will result in parts of increased quality and consistency.

Alternatively, another very accurate way to produce repeatably consistent parts is by using an actual melt pressure transducer at or near a nozzle tip of the injection unit which is in contact with the pressurized molten plastic material. However, the cost associated with these sensors can be thousands of dollars. In addition, the insertion of a sensor into the plastic melt flow can possibly cause dead spots or shear as well as by a potential cause for plastic leakage which in turn may damage the melt pressure transducer, further adding to the cost in both replacement of the sensor as well as down time.

Specifically, a method for controlling an injection molding process based upon accurate actual plastic melt pressure includes injecting molten thermoplastic material into a mold cavity. The method further includes measuring, using a sensor at or near the back of the screw, a pressure of the molten thermoplastic material during injection, and calculating, by an algorithm, the measured pressure of the molten thermoplastic material over time during the cycle.

The method for controlling an injection molding process based upon accurate actual plastic melt pressure may be used in a conventional injection molding process or in a substantially low constant pressure injection molding process. The method may also be used in other molding processes, such as metal injection molding (MIM), reaction injection molding (RIM), liquid injection molding (LIM), structural foam molding, liquid crystal polymer (LCP) molding, and injection-stretch blow molding. In a conventional injection molding process, adjusting the injection pressure in order to cause the actual melt pressure of the molten thermoplastic material during the cycle to follow the actual plastic melt pressure curve setpoint over time may occur during at least one of a packing or a holding phase of the cycle. In a substantially low constant pressure injection molding process, adjusting the injection pressure in order to cause the actual melt pressure of the molten thermoplastic material during the cycle to follow the actual plastic melt pressure curve setpoint over time may occur during all of the cycle.

The method for controlling an injection molding process based upon an actual plastic melt pressure may also include applying a machine learning algorithm to determine an alteration to the optimal actual plastic melt pressure curve. For example, in some implementations, performance of a plurality of injection cycles is monitored for a plurality of different injection molding machines, mold, and molten materials. This historical data can be used as an input to train the machine learning algorithm to correlate the characteristics of the injection molding machine, mold, and/or molten material, the optimal actual plastic melt pressure curve used with such machines, molds, and/or molten materials, and a measured result (such as part quality), and then implement an alteration to the optimal actual plastic melt pressure curve for such a machine, mold, and/or molten material that will result in an improved measured result.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale. For example, the dimensions and/or relative positioning of some of the elements in the figures may be exaggerated relative to other elements to help to improve understanding of various embodiments of the present invention.

FIG. 1 illustrates a schematic view of an injection molding machine having a controller coupled thereto in accordance with various embodiments of the present disclosure;

FIG. 2 illustrates a plot of the error between actual melt pressure and melt pressure calculated from the pressure or force at the back of the screw using the intensification ratio; and

FIG. 3 illustrates an exemplary method for adjusting melt pressure in an injection molding machine.

### DETAILED DESCRIPTION

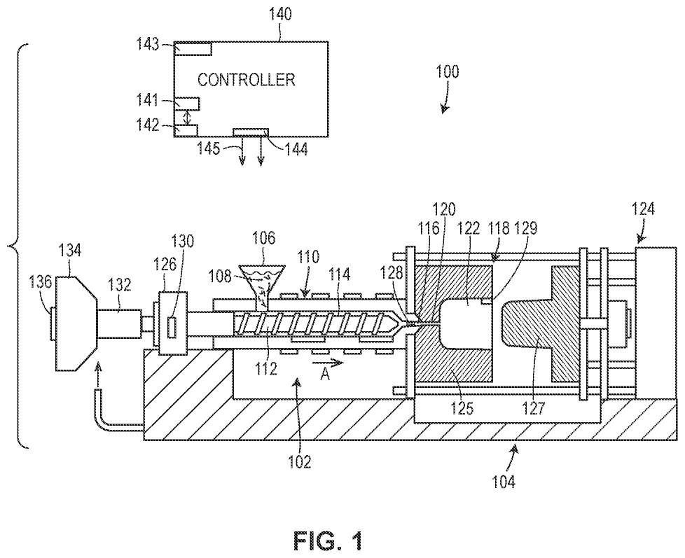

Turning to the drawings, an injection molding process is herein described. The approaches described herein may be suitable for electric presses, servo-hydraulic presses, hydraulic presses, and other known machines. As illustrated in FIG. 1, the injection molding machine 100 includes an injection unit 102 and a clamping system 104. FIG. 1 illustrates an injection molding machine 100 with a single injection unit 102. However, injection molding machine 100 can include multiple injection molding units. Multiple injection units may make the injection molding machine 100 suitable for co-injection molding. The injection molding machine 100 may operate at low, constant pressure.

The injection unit 102 includes a hopper 106 adapted to accept material in the form of pellets 108 or any other suitable form. In many of these examples, the pellets 108 may be a polymer or polymer-based material. Other examples are possible. The hopper 106 feeds the pellets 108 into a heated barrel 110 of the injection unit 102. Upon being fed into the heated barrel 110, the pellets 108 may be driven to the end of the heated barrel 110 by a reciprocating screw 112. The heating of the heated barrel 110 and the compression of the pellets 108 by the reciprocating screw 112 causes the pellets 108 to melt, thereby forming a molten plastic material 114. The pellets are melted under a combination of heat, pressure and shear. The molten plastic material 114 is typically processed at a temperature selected within a range of about 130° C. to about 410° C. (with manufacturers of particular polymers typically providing injection molders with recommended temperature ranges for given materials).

The reciprocating screw 112 advances forward from a first position to a second position, in the A direction, and forces the molten plastic material 114 toward a nozzle 116 to form a shot of plastic material that will ultimately be injected into a mold cavity 122 of a mold 118 via one or more gates 120 which direct the flow of the molten plastic material 114 to the mold cavity 122. In other words, the reciprocating screw 112 is driven to exert a force on the molten plastic material 114.

The force exerted on the molten plastic material 114 may be a melt pressure. The melt pressure may be determined from a pressure or force exerted on sensor 130. If the injection molding machine 100 is controlled hydraulically, the pressure exerted on sensor 130 may be a hydraulic pressure. If the injection molding machine 100 is controlled electrically, the force exerted on sensor 130 may be a force exerted on a load cell on the back of the screw 112. The hydraulic pressure or force exerted on sensor 130 may be exerted by motor 134 and ball screw 132. Additionally, sensor 136 may detect additional information associated with motor 134 such as the health of motor 134. Motor 134 may be a hydraulic motor or an electrical motor.

Additionally, the melt pressure may be determined from properties of the molten plastic material 114. For example, the melt pressure may be determined from the drag and compressibility associated with molten plastic material 114. Still further, the melt pressure may be determined from properties of the screw 112. For example, the geometry of the screw, which may affect the friction and drag due to compression of the molten plastic material 114 may affect the melt pressure.

Calculating the melt pressure of the molten plastic material 114 may include calculating an error associated with the melt pressure. The error may be constant or variable. The error may vary linearly or non-linearly. Further the variation in the error may be dependent on the point-in-time of the fill cycle. For example, the error may be greater at the beginning of a fill cycle than at the end of the fill cycle of the injection molding machine 100. Further, the error may be due to the compressibility of the molten plastic material 114 or the drag of the molten plastic material 114 or both.

In other embodiments, the nozzle 116 may be separated from one or more gates 120 by a feed system (not illustrated). The mold cavity 122 is formed between the first and second mold sides 125, 127 of the mold 118 and the first and second mold sides 125, 127 are held together under pressure via a press or clamping unit 124.

The press or clamping unit 124 applies a predetermined clamping force during the molding process which is greater than the force exerted by the injection pressure acting to separate the two mold halves 125, 127, thereby holding together the first and second mold sides 125, 127 while the molten plastic material 114 is injected into the mold cavity 122. To support these clamping forces, the clamping system 104 may include a mold frame and a mold base, in addition to any other number of components, such as a tie bar.

Once the shot of molten plastic material 114 is injected into the mold cavity 122, the reciprocating screw 112 halts forward movement. The molten plastic material 114 takes the form of the mold cavity 122 and cools inside the mold 118 until the plastic material 114 solidifies. Upon solidifying, the press 124 releases the first and second mold sides 125, 127, which are then separated from one another. The finished part may then be ejected from the mold 118. The mold 118 may include any number of mold cavities 122 to increase overall production rates. The shapes and/or designs of the cavities may be identical, similar to, and/or different from each other. For instance, a family mold may include cavities of related component parts intended to mate or otherwise operate with one another. In some forms, an “injection cycle” is defined as of the steps and functions performed between commencement of injection and ejection. Upon completion of the injection cycle, a recovery profile is commenced during which the reciprocating screw 112 returns to the first position, opposite direction A.

The injection molding machine 100 also includes a controller 140 communicatively coupled with the machine 100 via connection 145. The connection 145 may be any type of wired and/or wireless communications protocol adapted to transmit and/or receive electronic signals. In these examples, the controller 140 is in signal communication with at least one sensor, such as, for example, sensor 128 located in or near the nozzle 116 and/or a sensor 129 located in or near the mold cavity 122. In some examples, the sensor 128 is located at a leading end of the screw 112 and the sensor 129 is located in a manifold or a runner of the injection machine 100. Alternatively, the sensor 128 may be located at any position ahead of the check ring of the screw 112. It is understood that any number of additional real and/or virtual sensors capable of sensing any number of characteristics of the mold 118 and/or the machine 100 may be used and placed at desired locations of the machine 100. As a further example, any type of sensor capable of detecting flow front progression in the mold cavity 122 may be used. Additionally, controller 140 may be in communication with sensor 130 and sensor 136.

The controller 140 can be disposed in a number of positions with respect to the injection molding machine 100. As examples, the controller 140 can be integral with the machine 100, contained in an enclosure that is mounted on the machine, contained in a separate enclosure that is positioned adjacent or proximate to the machine, or can be positioned remote from the machine. In some embodiments, the controller 140 can partially or fully control functions of the machine via wired and/or wired signal communications as known and/or commonly used in the art.

The sensor 128 may be any type of sensor adapted to measure (either directly or indirectly) one or more characteristics of the molten plastic material 114 and/or portions of the machine 100. The sensor 128 may measure any characteristics of the molten plastic material 114 that are known and used in the art, such as, for example, a back pressure, temperature, viscosity, flow rate, hardness, strain, optical characteristics such as translucency, color, light refraction, and/or light reflection, or any one or more of any number of additional characteristics which are indicative of these. The sensor 128 may or may not be in direct contact with the molten plastic material 114. In some examples, the sensor 128 may be adapted to measure any number of characteristics of the injection molding machine 100 and not just those characteristics pertaining to the molten plastic material 114. As an example, the sensor 128 may be a pressure transducer that measures a melt pressure (during the injection cycle) and/or a back pressure (during the extrusion profile and/or recovery profile) of the molten plastic material 114 at the nozzle 116.

As previously noted, the sensor 128 may measure a back pressure exerted on the screw 112, but unlike in conventional systems where back pressure is measured on a trailing end of the screw 112, in the present approaches, back pressure is measured on a leading end of the screw 112. This positioning allows the sensor 128 to accurately measure the compressive pressure on the molten plastic material 114 as compared to measurements obtained at the trailing end of the screw 112 due to the compressible nature of the molten plastic material 114, draw in the barrel, and other factors. Although there are many options for the purchasing the type of sensor 128 that is used, there are no known machines that incorporate this sensor location for injection or back pressure control.

The sensor 128 generates a signal which is transmitted to an input of the controller 140. If the sensor 128 is not located within the nozzle 116, the controller 140 can be set, configured, and/or programmed with logic, commands, and/or executable program instructions to provide appropriate correction factors to estimate or calculate values for the measured characteristic in the nozzle 116. For example, as previously noted, the sensor 128 may be programmed to measure a back pressure during a recovery profile. The controller 140 may receive these measurements and may translate the measurements to other characteristics of the molten plastic material 114, such as a viscosity value.

Similarly, the sensor 129 may be any type of sensor adapted to measure (either directly or indirectly) one or more characteristics of the molten plastic material 114 to detect its presence and/or condition in the mold cavity 122. In various embodiments, the sensor 129 may be located at or near an end-of-fill position in the mold cavity 122. The sensor 129 may measure any number of characteristics of the molten plastic material 114 and/or the mold cavity 122 that are known in the art, such as pressure, temperature, viscosity, flow rate, hardness, strain, optical characteristics such as translucency, color, light refraction, and/or light reflection, and the like, or any one or more of any number of additional characteristics indicative of these. The sensor 129 may or may not be in direct contact with the molten plastic material 114. As an example, the sensor 129 may be a pressure transducer that measures a cavity pressure of the molten plastic material 114 within the cavity 122. The sensor 129 generates a signal which is transmitted to an input of the controller 140.

Sensor 130 may be any type of sensor adapted to measure (either directly or indirectly) the a property associated with the injection of the molten plastic material 114 by the screw 112. The sensor 130 may or may not be in direct contact with the molten plastic material 114. As an example, the sensor 130 may measure the properties of stress, strain, compressibility, rheology, load cell pressure, and/or hydraulic pressure. Additionally, the sensor 130 may be located within the screw 112, behind the screw 112, in front of the tip of the screw 112, in the nozzle 116, in a gate of the injection molding machine 120, or in at least one cavity of a mold 122. The sensor 130 generates a signal which is transmitted to an input of the controller 140. Any number of additional sensors may be used to sense and/or measure operating parameters.

The controller 140 is also in signal communication with a screw control 126. In some embodiments, the controller 140 generates a signal which is transmitted from an output of the controller 140 to the screw control 126. The controller 140 can control any number of characteristics of the machine, such as injection pressures (by controlling the screw control 126 to advance the screw 112 at a rate which maintains a desired value corresponding to the molten plastic material 114 in the nozzle 116), barrel temperatures, clamp closing and/or opening speeds, cooling time, inject forward time, overall cycle time, pressure set points, ejection time, screw recovery speed, back pressure values exerted on the screw 112, and screw velocity.

The signal or signals from the controller 140 may generally be used to control operation of the molding process such that variations in material viscosity, mold temperatures, melt temperatures, and other variations influencing filling rate are taken into account by the controller 140. Alternatively or additionally, the controller 140 may make necessary adjustments in order to control for material characteristics such as volume and/or viscosity. Adjustments may be made by the controller 140 in real time or in near-real time (that is, with a minimal delay between sensors 128, 129, 130 sensing values and changes being made to the process), or corrections can be made in subsequent cycles. Furthermore, several signals derived from any number of individual cycles may be used as a basis for making adjustments to the molding process. The controller 140 may be connected to the sensors 128, 129, 130, the screw control 126, and or any other components in the machine 100 via any type of signal communication approach known in the art.

Based on the property measured by sensor 130, the controller 140 can calculate a value indicative of a melt pressure of the molten plastic material 114. In addition to the property measured by sensor 130, the controller 140 may further calculate the value indicative of the melt pressure based on another measured property associated with the injection of the molten plastic material 114 such as a measured property sensed by sensors 128 and 129. Further, based on the value indicative of the melt pressure and a desired melt pressure of the molten plastic material 114 as a function of time, the controller 140 may adjust operation of the injection molding machine 100 and more particularly the screw control 126 to adjust the injection of the molten plastic material 114 in an effort to minimize any difference between the melt pressure and the desired melt pressure. In addition to adjusting the operation of the injection molding machine 100 based on the value indicative of the melt pressure, the controller 140 can adjust the operation based on an error associated with the value indicative of the melt pressure.

The value indicative of the melt pressure further may be calculated based on a relationship between the melt pressure and the measured property, one or more properties of the molten plastic material 114, one or more properties of the screw 112 of the injection molding machine 100, and/or one or more know relationships between the melt pressure and the measured property. The one or more known relationships may be determined from previous testing or use of the injection molding machine 100. Further the controller 140 may use a machine learning algorithm to, based on the value indicative of the melt pressure and the desired melt pressure of the molten plastic material 114, adjust operation of the injection molding machine 100.

The controller 140 includes software 141 adapted to control its operation, any number of hardware elements 142 (such as, for example, a non-transitory memory module and/or processors), any number of inputs 143, any number of outputs 144, and any number of connections 145. The software 141 may be loaded directly onto a non-transitory memory module of the controller 140 in the form of a non-transitory computer readable medium, or may alternatively be located remotely from the controller 140 and be in communication with the controller 140 via any number of controlling approaches. The software 141 includes logic, commands, and/or executable program instructions which may contain logic and/or commands for controlling the injection molding machine 100 according to a mold cycle. The software 141 may or may not include an operating system, an operating environment, an application environment, and/or a user interface.

The hardware 142 uses the inputs 143 to receive signals, data, and information from the injection molding machine being controlled by the controller 140. The hardware 142 uses the outputs 144 to send signals, data, and/or other information to the injection molding machine. The connection 145 represents a pathway through which signals, data, and information can be transmitted between the controller 140 and its injection molding machine 100. In various embodiments this pathway may be a physical connection or a non-physical communication link that works analogous to a physical connection, direct or indirect, configured in any way described herein or known in the art. In various embodiments, the controller 140 can be configured in any additional or alternate way known in the art.

The connection 145 represents a pathway through which signals, data, and information can be transmitted between the controller 140 and the injection molding machine 100. In various embodiments, these pathways may be physical connections or non-physical communication links that work analogously to either direct or indirect physical connections configured in any way described herein or known in the art. In various embodiments, the controller 140 can be configured in any additional or alternate way known in the art.

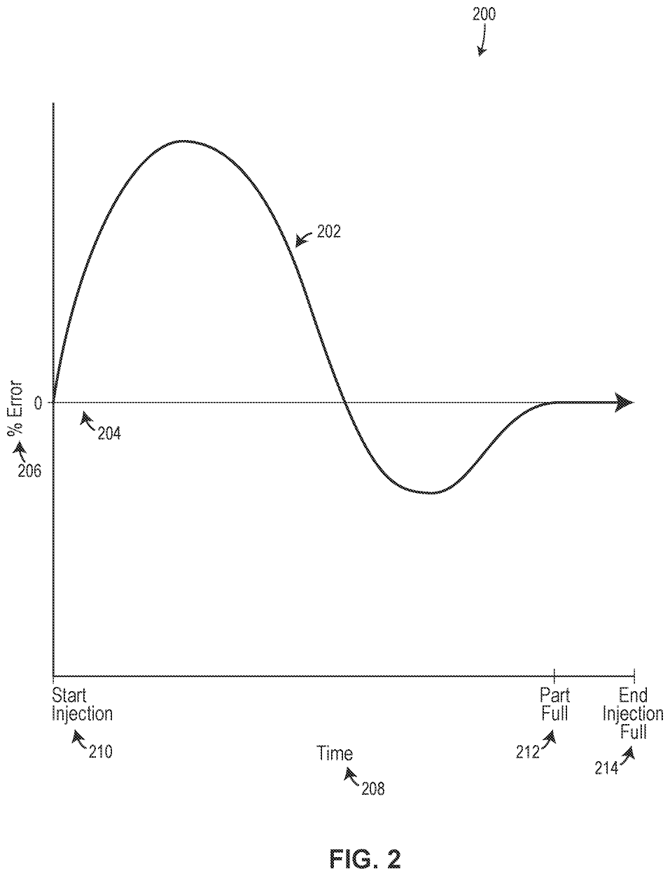

FIG. 2 depicts a plot 200 of the error between actual melt pressure and melt pressure calculated from the pressure or force at the back of the screw using the intensification ration. The plot 200 may be associated with conventional systems and may be a plot of “Percent Error” 206 versus “Time” 208. The “Percent Error” may be a percent error between the calculated melt pressure and the actual melt pressure of a molten plastic material 114. Within plot 200, a percent error of 0 may be depicted by line 204.

The percent error of a conventional system between calculated melt pressure and actual melt pressure may be depicted by line 202. The error may be due to the drag of molten plastic material 114 within screw 112 or may be due to compressibility of molten plastic material 114. The percent error may be greater during the beginning of the injection molding shot between the start of the injection 210 and a part, such as part 122 becoming full 212. This is because as the part fills, the drag and compressibility associated with the molten plastic material 114 may decrease. While the part is full but still being packed, between the part full 212 point and the end of injection 214, the percent error may approach zero.

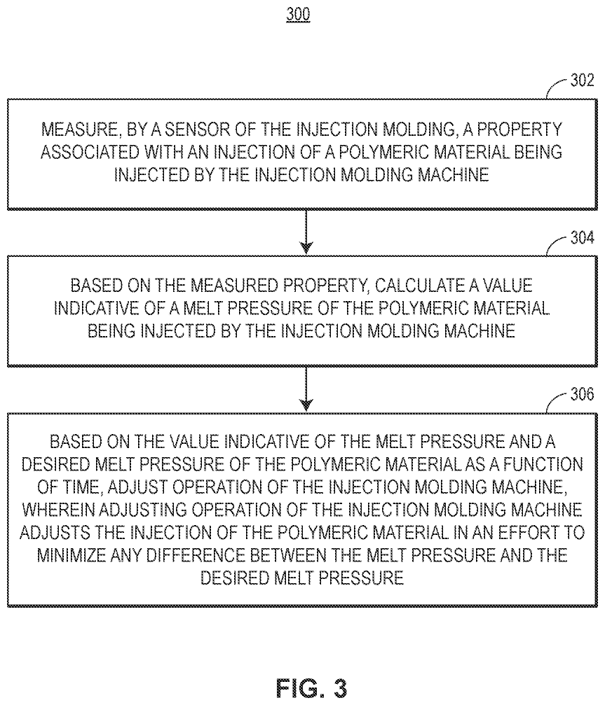

FIG. 3 illustrates an exemplary flow diagram 300 for adjusting melt pressure in an injection molding machine, such as injection molding machine 100. The method 300 may be performed by a controlled of an injection molding machine, such as controller 140.

At step 302, the controller measures by a sensor (e.g. sensor 130) of the injection molding machine, a property associated with an injection of a polymeric material being injected by the injection molding machine. The injection molding machine may operate at low, constant pressure. The property may be stress, strain, drag, compressibility, rheology, load cell pressure, and hydraulic pressure. The sensor may be within a screw of the injection molding machine, behind the screw of the injection molding machine, in front of a tip of the screw of the injection molding machine, in a nozzle of the injection molding machine, in a gate of the injection molding machine, or in at least one cavity of a mold received in the injection molding machine.

At step 304, based on the measured property, the controller 140 calculates a value indicative of a melt pressure of the polymeric material 114 being injected by the injection molding machine 110. Calculating the value indicative of the melt pressure of the polymeric material 114 may include estimating an error associated with the value. Further the error may be constant or variable. In the case that the error is variable, the error may be greater at the beginning of a fill cycle than at the end of the fill cycle of the injection molding machine 100 as further depicted in FIG. 2. The error may be at least the result of compressibility or drag associated with the polymeric material 114.

Calculating the value indicative of the melt pressure may further include the controller 140 calculating the value of the melt pressure based on a relationship between the melt pressure and the measured property. Additionally, the controller 140 may calculate another property associated with the injection of the polymeric material 114 and based on the measured property and the other property, calculate the value indicative of the melt pressure of the polymeric material 114. Further, the controller 140 may calculate the value indicative of the melt pressure based on one or more properties of the polymeric material 114 and/or one or more properties of the screw 112 of the injection molding machine. Additionally, the controller 140 may calculate the value of the value of the melt pressure based on one or more known relationships between the melt pressure and the measured property from previous testing.

At step 306, the controller 140 may be based on the value indicative of the melt pressure and a desired melt pressure of the polymeric material 114 as a function of time, adjust operation of the injection molding machine 110, wherein adjusting operation of the injection molding machine 110 adjusts the injection of the polymeric material 114 in an effort to minimize any difference between the melt pressure and the desired melt pressure. Adjusting the operation of the injection molding machine 110 may further comprise adjusting operation of the injection molding machine based on the estimated error. The controller 140 may use a machine learning algorithm to, based on the value indicative of the melt pressure and the desired melt pressure of the polymeric material 114 as a function of time, adjust operation of the injection molding machine 110.

While various embodiments have been described herein, it will be understood that modifications may be made thereto that are still considered within the scope of the appended claims.

What is claimed is:

1. A method of adjusting melt pressure in an injection molding machine, the method comprising:
measuring, by a sensor of the injection molding, a property associated with an injection of a polymeric material being injected by the injection molding machine;
based on the measured property, calculating a value indicative of a melt pressure of the polymeric material being injected by the injection molding machine;
based on the value indicative of the melt pressure and a desired melt pressure of the polymeric material as a function of time, adjusting operation of the injection molding machine, wherein adjusting operation of the injection molding machine adjusts the injection of the polymeric material in an effort to minimize any difference between the melt pressure and the desired melt pressure.

2. The method of claim 1, wherein calculating the value indicative of the melt pressure of the polymeric material further comprises estimating an error associated with the value.

3. The method of claim 2, wherein adjusting operation of the injection molding machine further comprises adjusting operation of the injection molding machine based on the estimated error.

4. The method of claim 2, wherein the error is constant.

5. The method of claim 2, wherein the error is variable.

6. The method of claim 5, wherein the error is greater at a beginning of a fill cycle of the injection molding machine than at an end of the fill cycle of an injection molding machine.

7. The method of claim 5, wherein the error changes one of linearly or non-linearly.

8. The method of claim 2, wherein the error is a result of at least one of the compressibility or the drag of the polymeric material.

9. The method of claim 1, wherein the property is one of a group including stress, strain, drag, compressibility, rheology, load cell pressure, and hydraulic pressure.

10. The method of claim 1, further comprising:
measuring, by another sensor of the injection molding machine, another property associated with the injection of the polymeric material; and
based on the measured property and the another measured property, calculating the value indicative of a melt pressure of the polymeric material.

11. The method of claim 1, wherein the sensor is one of within a screw of the injection molding machine, behind the screw of the injection molding machine, in front of a tip of the screw of the injection molding machine, in a nozzle of the injection molding machine, in a gate of the injection molding machine, or in at least one cavity of a mold received in the injection molding machine.

12. The method of claim 1, wherein calculating the value indicative of the melt pressure further comprises calculating the value of the melt pressure from a relationship between the melt pressure and the measured property.

13. The method of claim 12, further comprising calculating the value indicative of the melt pressure based on one or more properties of the polymeric material and/or one or more properties of the screw of the injection molding machine.

14. The method of claim 1, wherein calculating the value indicative of the melt pressure further comprises calculating the value of the melt pressure based on one or more known relationships between the melt pressure and the measured property from previous testing.

15. The method of claim 1, wherein the injection molding machine operates at low, constant pressure.

16. The method of claim 1, further comprising using a machine learning algorithm to, based on the value indicative of the melt pressure and the desired melt pressure of the polymeric material as a function of time, adjust operation of the injection molding machine.

17. A system for adjusting melt pressure during injection molding, the system comprising:
an injection molding machine comprising:
an injection unit configured to inject a polymeric material, and
a sensor configured to measure a property associated with the injection of the polymeric material; and
a controller communicatively coupled to the injection molding machine and configured to:
based on the measured property, calculate a value indicative of a melt pressure of the polymeric material, and
based on the value indicative of the melt pressure and a desired melt pressure of the polymeric material as a function of time, adjust operation of the injection molding machine, wherein adjusting operation of the injection molding machine adjusts the injection of the polymeric material in an effort to minimize any difference between the melt pressure and the desired melt pressure.

18. The system of claim 17, wherein in calculating the value indicative of the melt pressure of the polymeric material, the controller is further configured to estimate an error associated with the value.

19. The method of claim 18, wherein in adjusting operation of the injection molding machine, the controller is further configured to adjust operation of the injection molding machine based on the estimated error.

20. The method of claim 18, wherein the error is a result of at least one of the compressibility or the drag of the polymeric material.
